(19) United States
(12) Patent Application Publication
(10) Pub. No.: US 2005/0214563 A1
(43) Pub. Date: Sep. 29, 2005

(54) Modified bond coat for increasing the cyclic spallation life of thermal barrier coating

(75) Inventors: Ganjiang Feng, Greenville, SC (US); Paul Stephen DiMascio, Greer, SC (US); Ravindra Annigeri, Roswell, GA (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 10/810,856

(22) Filed: Mar. 29, 2004

(51) Int. Cl. B32B 15/04

(52) U.S. Cl. 428/629; 428/678; 428/633; 416/241 B; 416/241 R

(57) ABSTRACT

Method of stabilizing adherence of a ceramic layer to a bond coat of a TBC system, comprising incorporating silicon into the bond coat and maintaining cobalt present in the bond coat at a minimum level.

The present invention relates to improving the life of a thermal barrier coating (TBC) system for gas turbine components. More particularly, the present invention provides a method for improving oxidation/hot corrosion resistance of the metallic bond coat of the TBC system and increasing the temperature capability and life of the TBC system by the addition of a controlled amount of silicon to the bond coat of the TBC system while cobalt present in the bond coat is maintained at a minimum level.

### BACKGROUND OF THE INVENTION

TBC coating systems are widely used in power generation and aircraft gas turbines to protect superalloy components. TBC coating systems typically comprise a metallic bond coat and a ceramic coating which typically contains zirconia stabilized with yttria.

Coatings which have been employed to protect high temperature superalloy turbine components are MCrAlY coatings, where M typically represents nickel, cobalt, iron or mixtures of any of these elements. However, TBC coatings are susceptible to delamination and spalling during gas turbine operation, which is undesirable.

In order to counter this, a variety of alloying additions has been proposed for the MCrAlY coating, to improve the oxidation resistance, resistance to delamination and spalling, and other thermal performance. It has been found, for example, that the addition of silicon to the MCrAlY coating can significantly improve its oxidation resistance. U.S. Pat. No. 4,034,142 (1977) describes a MCrAlY coating containing from 0.5 to 7% silicon. U.S. Pat. No. 4,419,416 (1983) describes a MCrAlY coating with silicon and hafnium additions. U.S. Pat. No. 4,585,481 (1986) describes a MCrAlY coating preferably applied by plasma spraying with silicon and hafnium particles.

However, none of these coatings was proposed either for the TBC bond coat application or to improve thermal stability of the TBC system. Another drawback of the prior art is the use of co-sprayed silicon powder, which may result in non-uniformly distributed silicon particles throughout the coating and is of high potential to form silicon oxide during the spray operation.

It is known that the effectiveness of silicon addition will be greatly reduced by the formation of silicon oxide. U.S. Pat. No. 4,861,618 (1987) describes a NiCoCrAlY bond coat for TBC system, which may contain 0 to 7% Si and 0 to 2% Hf. However, the effect of the Si level on the TBC spallation life is not discussed in the patent.

A need exists for a method of improving the life of thermal barrier coatings (TBC) for gas turbine components by improving oxidation/hot corrosion resistance of the coating while minimizing spalling and delamination of the coating. The present invention seeks to fill that need.

### BRIEF SUMMARY OF THE INVENTION

It has now been found, according to the present invention, that the problem of spalling and delamination discussed above is most likely related to the unstable growth of thermally grown oxide (TGO) at the ceramic layer/metallic bond coat interface. Such TGO growth causes stress at the ceramic layer/metallic bond coat interface. If TBC life is to be improved, it is important to achieve enhanced adherence and thermal stability of thermally grown oxide (TGO). For overlays, the adhesion of the TGO may be of prime importance. For TBC bond coats, it is more the rate of growth of the TGO, as spallation of the ceramic layer tends to occur when the TGO reaches a critical thickness.

The present inventors have compared the effect of Si addition on TBC spallation life with both NiCrAlY and NiCoCrAlY bond coats. It has been found that the addition of silicon to NiCrAlY bond coat effectively increases TBC spallation life. It has also been observed that more deleterious effects are observed when the level of cobalt increases above about 5 wt %.

The present inventors have further discovered, surprisingly, that the formation of silicon dioxide should be minimized, as it is believed that the effectiveness of silicon addition to the bond coat is significantly reduced by the formation of silicon oxide. This may be achieved by keeping the silicon content in the range of 5 wt % or less, more usually 4 wt % or less.

In one aspect, the present invention provides a method of stabilizing adherence of a ceramic layer to a bond coat of a TBC system, comprising incorporating silicon into the bond coat and maintaining cobalt present in said bond coat at a minimum level.

In a further aspect, there is provided a gas turbine component comprising a TBC system having a metallic bond coat and a ceramic layer, said bond coat comprising silicon, and cobalt at a minimum level.

### BRIEF DESCRIPTION OF THE DRAWINGS

FIG. 1 shows the results of testing TBC specimens with various bond coats in air for thermal cycle spallation; and

FIGS. 2a and 2b show the comparison of coating 1 and coating 3 in the thickness of aluminum inward diffusion layer.

### DETAILED DESCRIPTION OF THE INVENTION

The silicon bond coat powder is applied to superalloy components typically by thermal spraying process using a pre-alloyed MCrAlY powder. The powder typically contains 0.1 to 8 weight percent silicon, more usually 0.5 to 4 weight percent silicon. A continuous silicon-enriched layer is typically formed under thermally grown oxide (TGO), which provides a barrier to slow down inward diffusion of oxygen and sulfur ions and outward diffusion of aluminum and chromium.

Typical composition ranges of the proposed TBC bond coat in the present invention are given below:

| Chromium | Aluminum | Yttrium | Silicon | Cobalt | Nickel |
|---|---|---|---|---|---|
| 5-30% | 5-20% | 0.1-5% | 1.0-4.0% | 0-5% | Balance |

The elements shown above are major alloying elements. Minor elements may be added to the above composition to enhance oxidation performance of the silicon-modified bond coat. Cobalt, if present, is maintained at a minimum level. The term “minimum level” as used herein means no higher than about 10 wt %, more usually no higher than about 6 wt %, typically in the range of 0-5 wt %, for example 0-3 wt %, particularly 0-1 wt %. Although the pre-alloyed powder is preferred, co-sprayed powder mixture may also be used provided a uniform and continuous coating of the desired composition is achieved.

The performance of the modified NiCrAlY bond coat discussed above was evaluated by machining disk specimens 0.125 inches thick, 1 inch in diameter from GTD-111® casting slab, having nominal composition of 14 wt % chromium, 9 wt % cobalt, 3 wt % aluminum, 4.9 wt % titanium, 3 wt % tantalum, 3.7 wt % tungsten, 1.5 wt % molybdenum and the balance nickel. Bond coats with 8 different coating compositions were applied using High Velocity Oxy-Fuel Flame (HVOF) process. The compositions are shown in Table 1 in weight percent.

TABLE 1

| Coatings | Cr | Al | Ni | Co | Y | Si |
|---|---|---|---|---|---|---|
| 1 | 23.0 | 10.5 | Balance | — | 1.00 | — |
| 2 | 21.8 | 10.3 | Balance | — | 0.95 | 1.0 |
| 3 | 21.9 | 10.1 | Balance | — | 1.04 | 2.5 |
| 4 | 21.4 | 10.2 | Balance | — | 1.06 | 3.8 |
| 5 | 21.4 | 10.4 | 33.0 | Balance | 0.30 | — |
| 6 | 21.8 | 10.3 | 33.3 | Balance | 0.46 | 1.1 |
| 7 | 21.7 | 10.2 | 32.2 | Balance | 0.34 | 2.4 |
| 8 | 21.8 | 10.3 | 31.9 | Balance | 0.30 | 3.8 |

It can be seen that coating 1 is the NiCrAIY baseline. Coatings 2 to 4 are the modified coating proposed in this invention. Coating 5 and coatings 6 to 8 represent NiCoCrAlY baseline coat and the Si-modified reversions. The ceramic topcoat consisting of zirconium oxide and yttrium oxide was deposited on the bond coat to a thickness of about 0.02 inches using plasma spray process.

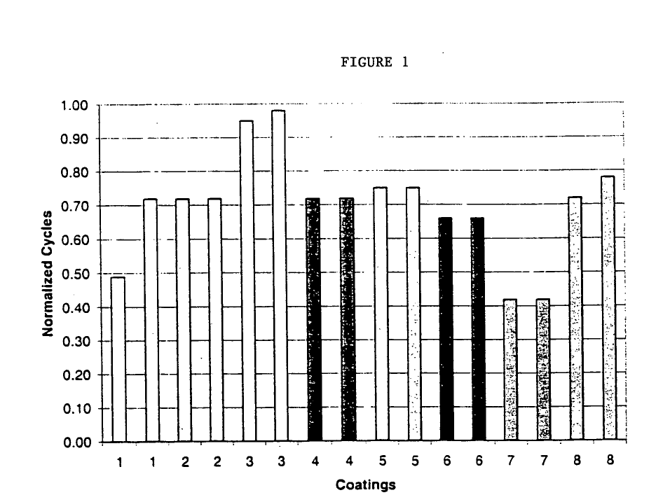

The coated TBC specimens with various bond coats were tested in air for thermal cycle spallation. The specimens were tested at 2000° F. in a cycle consisting of a 9 minute heating to 2000° F. from the 400° F., holding at 2000° F. for 45 minutes, and cooling to 400° F. in 10 minutes. The results are summarized in FIG. 1. The number of cycles to spallation is defined as the loss of 10 percent of the TBC coating. It can be seen that TBC coatings with Si-modified NiCrAlY bond coat provided superior spallation life compared the coating with NiCrAlY baseline bond coat. The spallation life appears to reach optimal at 2.5% Si level. On the other hand, the addition of Si to NiCoCrAlY bond coat seems to have little or no benefit to the TBC sapllation life.

To further verify the effect of Si on the bond coat stability, modified NiCrAlY bond coats were exposed in air at 1900° F. for up to 4000 hours. During the exposure, the high aluminum concentration in the bond coat is gradually reduced due to the inevitable progress of aluminum diffusion and oxidation. The aluminum diffusion occurred in the both directions. The inward diffusion transports aluminum into the substrate. The outward diffusion transports aluminum to form oxide layer on the surface. When the aluminum level of the bond coat drops to a certain point the coating is no longer effective. For a coating to be protective, it must resist transport of aluminum and oxygen ions. Therefore, the diffusion layer thickness is indicative of stability of a coating.

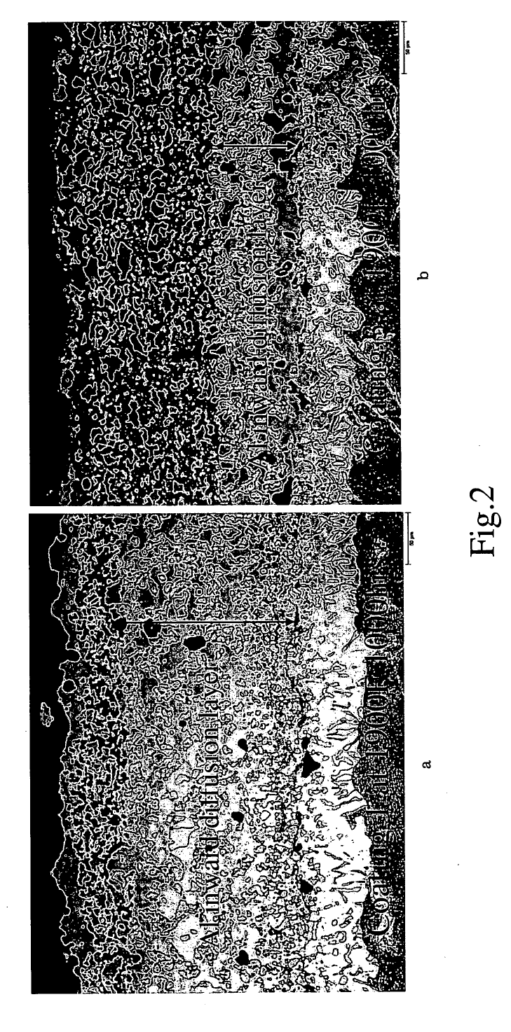

FIG. 2 shows the comparison of coating 1 and coating 3 in the thickness of aluminum inward diffusion layer. The results indicate that the aluminum depletion rate is significantly reduced due to the addition of silicon.

The above results clearly point out that the addition of a small amount of silicon slows down the aluminum diffusion rate and, therefore, improves the coating lifetime. It is believed that keeping silicon in the atomic form is an important factor to ensure the superior performance of the coating. If the silicon content of the coating is greater than 4%, the coating has a tendency to loose silicon through the formation of glassy silicide, which will reduce the stability of the coating.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of stablizing adherence of a ceramic layer to a bond coat of a TBC system, comprising incorporating silicon into the bond coat and maintaining cobalt present in said bond coat at a minimum level.

2. A method according to claim 1 wherein said bond coat comprises MCrAlY, wherein M is selected from the group consisting of nickel, cobalt, iron and mixtures thereof.

3. A method according to claim 1 wherein chromium is present in an amount of 3-40 wt %.

4. A method according to claim 1 wherein chromium is present in an amount of 5-30 wt %.

5. A method according to claim 1 wherein aluminum is present in an amount of 3-30 wt %.

6. A method according to claim 1 wherein aluminum is present in an amount of 5-20 wt %.

7. A method according to claim 1 wherein yttrium is present in an amount of 0.1-8 wt %.

8. A method according to claim 1 wherein yttrium is present in an amount of 0.1-5 wt %.

9. A method according to claim 1 wherein silicon is present in an amount of 0.3-5.0 wt %.

10. A method according to claim 1 wherein silicon is present in an amount of 0.5-4.0 wt %.

11. A method according to claim 1 wherein cobalt is present in an amount of 0-5 wt %.

12. A method according to claim 11 wherein cobalt is present in an amount of 0-1 wt %.

13. A method according to claim 1 wherein nickel is present in an amount of 15-45 wt %.

14. A method according to claim 1 wherein nickel is present in an amount of 20-40 wt %.

15. A gas turbine component comprising a TBC system having a metallic bond coat and a ceramic layer, said bond coat comprising silicon, and cobalt at a minimum level.

16. A gas turbine component according to claim 14, wherein said silicon is present in an amount of 0.5-5 wt %.

17. A gas turbine component according to claim 14, wherein said cobalt is present in an amount of 0 to 5 wt %.
